(19) United States
(12) Patent Application Publication
(10) Pub. No.: US 2018/0275314 A1
(43) Pub. Date: Sep. 27, 2018

(54) METHOD AND SYSTEM FOR SOLAR POWER FORECASTING

(71) Applicant: GREEN POWER LABS INC., DARTMOUTH, NS (CA)

(72) Inventors: Alexander PAVLOVSKI, BEDFORD (CA); Dimitriy ANICHKOV, SOMERVILLE, NJ (US); Vladimit KOSTYLEV, BEDFORD (CA)

(21) Appl. No.: 15/755,373

(22) PCT Filed: Aug. 29, 2016
(86) PCT No.: PCT/CA2016/000218

§ 371 Date: Feb. 26, 2018

Related U.S. Application Data
(60) Provisional application No. 62/211,924, filed on Aug. 31, 2015.

(51) Int. Cl. G01W 1/12; G01W 1/10; H02J 3/38; H02S 50/00; G06N 99/00

(52) U.S. Cl. CPC G01W 1/12; G01W 1/10; H02J 2003/007; H02S 50/00; G06N 99/005; H02J 3/383

(57) ABSTRACT

A method for generating a solar power output forecast for a solar power plant, comprising: using a processor, in a training mode, generating a trained artificial intelligence model using historical output data and historical input data including historical physical subsystem input data and historical physical subsystem forecasts for the solar power plant; in a runtime mode, for a predetermined forecast horizon, applying the trained artificial intelligence model to current input data including current physical subsystem input data and current physical subsystem forecasts for the solar power plant to produce the solar power output forecast; and, presenting the solar power output forecast on a display.

This application claims priority from and the benefit of the filing date of U.S. Provisional Patent Application No. 62/211,924, filed Aug. 31, 2015, and the entire content of such application is incorporated herein by reference.

### FIELD OF THE APPLICATION

This application relates to the field of environmental and energy forecasting, and more specifically, to a method and system for solar power forecasting.

### BACKGROUND OF THE APPLICATION

Operational solar power forecasting (e.g., intra-hour, hour(s) ahead, and day(s) ahead) has become a critically important service for solar power producers, utilities, and electricity system operators. Different market players use operational solar power forecasting for different purposes. For example, solar power producers may use it for optimized operations and management, and for market operations. Power utilities may apply forecasts to market, transmission and distribution management. And, electricity system operators may use forecasts for market management and power reliability applications.

Existing forecasting methods used in the industry may be broadly characterized as physical or statistical. The physical approach uses solar irradiation and photovoltaic (“PV”) power conversion models to generate PV plant output forecasts. In contrast, the statistical approach relies primarily on past data to “train” models, with little or no reliance on solar and PV models. (For example, see “INTERNATIONAL ENERGY AGENCY PHOTOVOLTAIC POWER SYSTEMS PROGRAMME”, Photovoltaic and Solar Forecasting: State of the Art, IEA PVPS Task 14, Subtask 3.1, Report IEA-PVPS T14-01: 2013, October 2013, ISBN 978-3-906042-13-8, page 6, which is incorporated herein by reference.)

The physical approach with respect to a single well characterized PV system is illustrated in FIG. 1. The above noted IEA PVPS report on Photovoltaic and Solar Forecasting (2013) states the following: “The main variables influencing PV output power are the irradiance in the plane of the PV array, Gᵢ, and the temperature at the back of the PV modules (or cells), Tₘ. For non-concentrating PV, the relevant irradiance is global irradiance in the array plane, while for concentrating PV it is direct normal irradiance. Other variables, such as the incidence angle of beam irradiance and the spectral distribution of irradiance, are included in some PV models, but high accuracies have been obtained with models that do not incorporate these effects. Depending on data availability, PV models can either be fitted to historical data [ . . . ] or else based on manufacturer specifications . . . . Since neither Gᵢ nor Tₘ are output by weather forecasts, these must be obtained instead from solar and PV models that calculate these from PV system specifications and weather forecasts, such as global horizontal irradiance (GHI) and ambient temperature forecasts. These solar and PV models make up the intermediate step [ . . . ]. Tₘ can be modelled from PV system specifications and from GHI and ambient temperature and, optionally, wind speed”. (Again, see “INTERNATIONAL ENERGY AGENCY PHOTOVOLTAIC POWER SYSTEMS PROGRAMME”, Photovoltaic and Solar Forecasting: State of the Art, IEA PVPS Task 14, Subtask 3.1, Report IEA-PVPS T14-01: 2013, October 2013, ISBN 978-3-906042-13-8, page 6, which is incorporated herein by reference.)

In contrast, the statistical approach does not use solar or PV models. Its starting point is a training dataset that contains PV power, as well as various inputs or potential inputs, such as numerical weather predication (“NWP”) model outputs (i.e., GHI, Tₘ or other), ground station or satellite data, PV system data, and so on. This dataset is used to train models, such as autoregressive or artificial intelligence models, that output a forecast of PV power at a given time based on past inputs available at the time when the model is run. (Again, see “INTERNATIONAL ENERGY AGENCY PHOTOVOLTAIC POWER SYSTEMS PROGRAMME”, Photovoltaic and Solar Forecasting: State of the Art, IEA PVPS Task 14, Subtask 3.1, Report IEA-PVPS T14-01: 2013, October 2013, ISBN 978-3-906042-13-8, page 7, which is incorporated herein by reference.)

Hybrid approaches have also been proposed. Physical and statistical approaches to solar power forecasting may be blended. The physical approach frequently makes use of model output statistics (“MOS”) methods that compare forecasts to observations over a training period in order to correct forecasts, for example, by removing systematic errors. Meanwhile, the best statistical approaches make use of the data developed by physical models to select input variables. (See “INTERNATIONAL ENERGY AGENCY PHOTOVOLTAIC POWER SYSTEMS PROGRAMME”, Photovoltaic and Solar Forecasting: State of the Art, IEA PVPS Task 14, Subtask 3.1, Report IEA-PVPS T14-01: 2013, October 2013, ISBN 978-3-906042-13-8, page 7, which is incorporated herein by reference.)

However, one problem with these methods and systems is that they are typically too general for practical or effective implementation. In addition, these methods and systems are typically limited with respect to the accuracy of forecasts that they produce.

A need therefore exists for an improved method and system for solar power forecasting. Accordingly, a solution that addresses, at least in part, the above and other shortcomings is desired.

### SUMMARY OF THE APPLICATION

According to one aspect of the application, there is provided a method for generating a solar power output forecast for a solar power plant, comprising: using a processor, in a training mode, generating a trained artificial intelligence model using historical output data and historical input data including historical physical subsystem input data and historical physical subsystem forecasts for the solar power plant; in a runtime mode, for a predetermined forecast horizon, applying the trained artificial intelligence model to current input data including current physical subsystem input data and current physical subsystem forecasts for the solar power plant to produce the solar power output forecast; and, presenting the solar power output forecast on a display.

In accordance with further aspects of the application, there is provided an apparatus such as a data processing system, a forecasting system, a control system, etc., a method for adapting same, as well as articles of manufacture such as a computer readable medium or product and computer program product or software product (e.g., comprising a non-transitory medium) having program instructions recorded thereon for practising the method of the application.

### BRIEF DESCRIPTION OF THE DRAWINGS

Further features and advantages of the embodiments of the present application will become apparent from the following detailed description, taken in combination with the appended drawings, in which:

FIG. 1 is a block diagram illustrating a typical system for implementing a physical approach for generating PV power forecasts from weather forecasts and PV system data in accordance with the prior art;

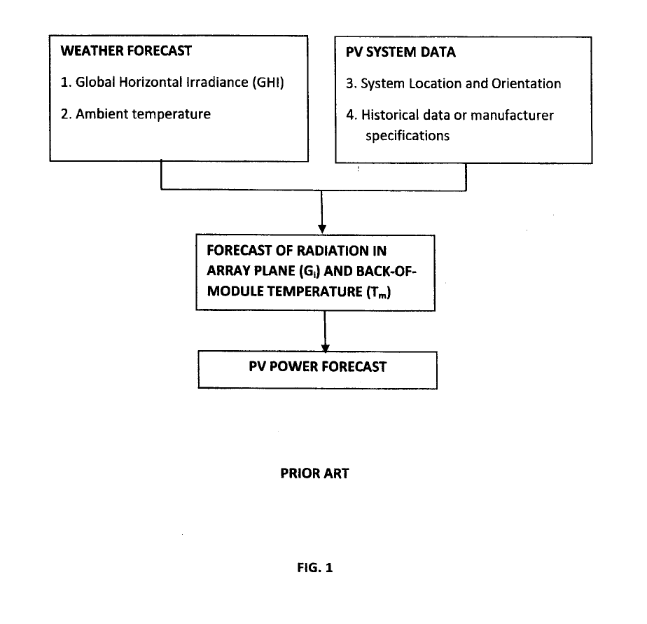

FIG. 2 is a block diagram illustrating a solar power forecasting system and architecture in accordance with an embodiment of the application;

FIG. 3 is a block diagram illustrating a deployment structure for the architecture of FIG. 2 in accordance with an embodiment of the application;

FIG. 4 is a block diagram illustrating a data processing system in accordance with an embodiment of the application;

FIG. 5 is a block diagram illustrating a hybrid physical and AI system for solar power forecasting in accordance with an embodiment of the application;

FIG. 6 is a graph illustrating AI model training to compensate for physical model bias in accordance with an embodiment of the application;

FIG. 7 is a graph illustrating AI model training to compensate for physical model timing error in accordance with an embodiment of the application;

FIG. 8 is a graph illustrating AI physical model refining in accordance with an embodiment of the application;

FIG. 9 is a flow diagram illustrating data flows within the solar power forecasting system in accordance with an embodiment of the application;

FIG. 10 is a flow diagram illustrating data flows between physical models within the solar power forecasting system in accordance with an embodiment of the application;

FIG. 11 is a flow diagram illustrating data flows within the clear sky model of FIG. 10 in accordance with an embodiment of the application;

FIG. 12 is a flow diagram illustrating data flows within the cloud model of FIG. 10 in accordance with an embodiment of the application;

FIG. 13 is a flow diagram illustrating data flows within the irradiance-to-electrical power model of FIG. 10 in accordance with an embodiment of the application; and,

FIG. 14 is a flow chart illustrating operations of modules within a data processing system for generating a solar power output forecast for a solar power plant, in accordance with an embodiment of the application.

It will be noted that throughout the appended drawings, like features are identified by like reference numerals.

### DETAILED DESCRIPTION OF THE EXAMPLE EMBODIMENTS

In the following description, details are set forth to provide an understanding of the application. In some instances, certain software, circuits, structures and methods have not been described or shown in detail in order not to obscure the application. The term “data processing system” or “system” is used herein to refer to any machine for processing data, including the computer systems, forecasting systems, control systems, and network arrangements described herein. The present application may be implemented in any computer programming language provided that the operating system of the data processing system provides the facilities that may support the requirements of the present application. Any limitations presented would be a result of a particular type of operating system or computer programming language and would not be a limitation of the present application. The present application may also be implemented in hardware or in a combination of hardware and software.

As mentioned above, the existing approaches to solar power forecasting may limit the accuracy of forecasts produced. However, physical and statistical models or a blend of those may be used in forecasting many variable phenomena. According to one embodiment of the present application, based on these general concepts, a new hybrid forecasting system is described that provides improved forecast accuracy due to its specific selection of physical and statistical models for matching characteristics of the forecast horizon and due to the efficient training, calibration, and operation of these models.

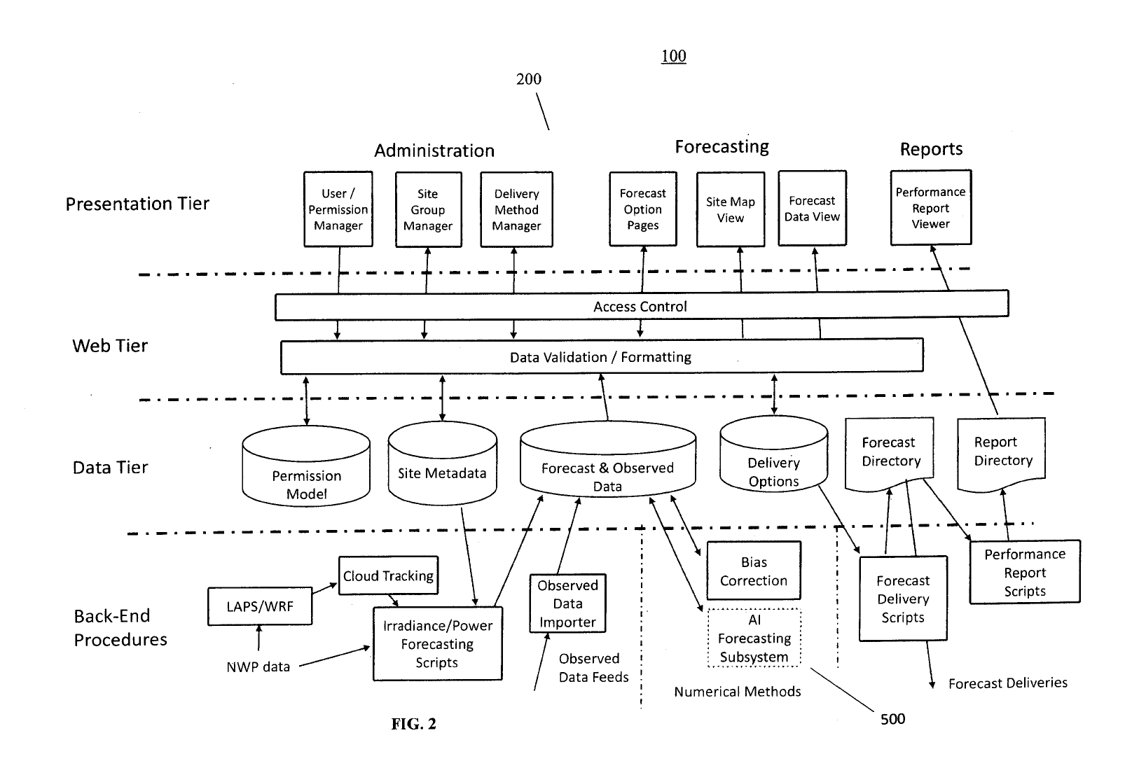

FIG. 2 is a block diagram illustrating a solar power forecasting system 100 and architecture 200 in accordance with an embodiment of the application. According to one embodiment of the present application, the solar power forecasting system 100 may have an architecture 200 which consists of four tiers. The four tiers may be as follows:
a) Presentation Tier. The web interface that is presented to the user through his/her web browser.
b) Application or Web Tier. The server-side component of the web application that processes user requests, and provides access control.
c) Data Tier. The data consists of the database and shared file system.
d) Back-End Procedures Tier. The procedures for generating forecasts, etc.

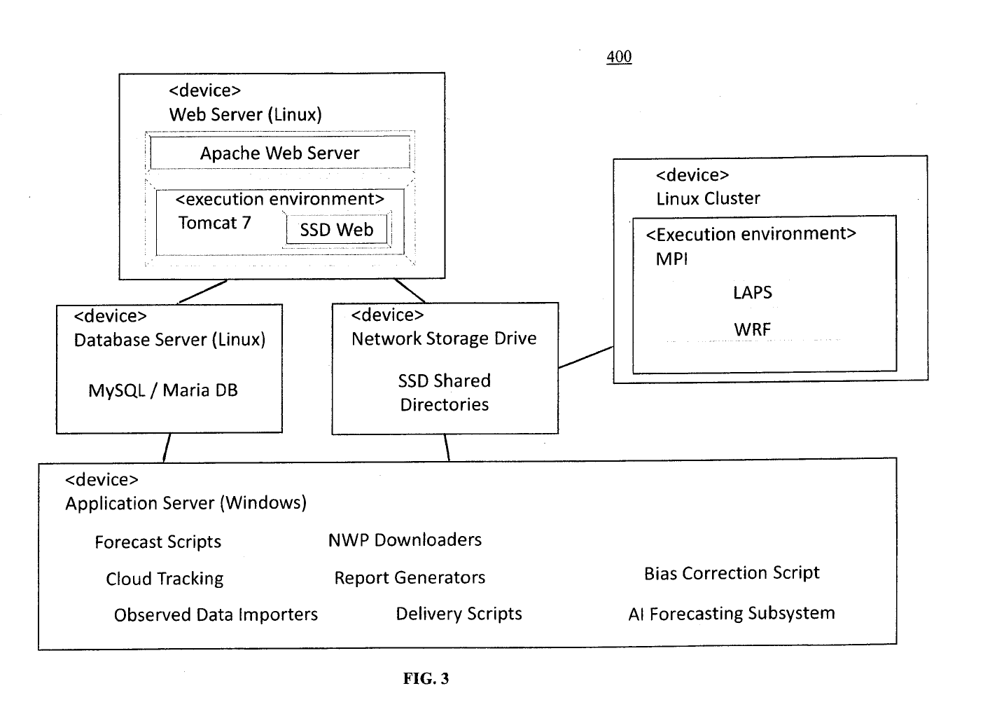

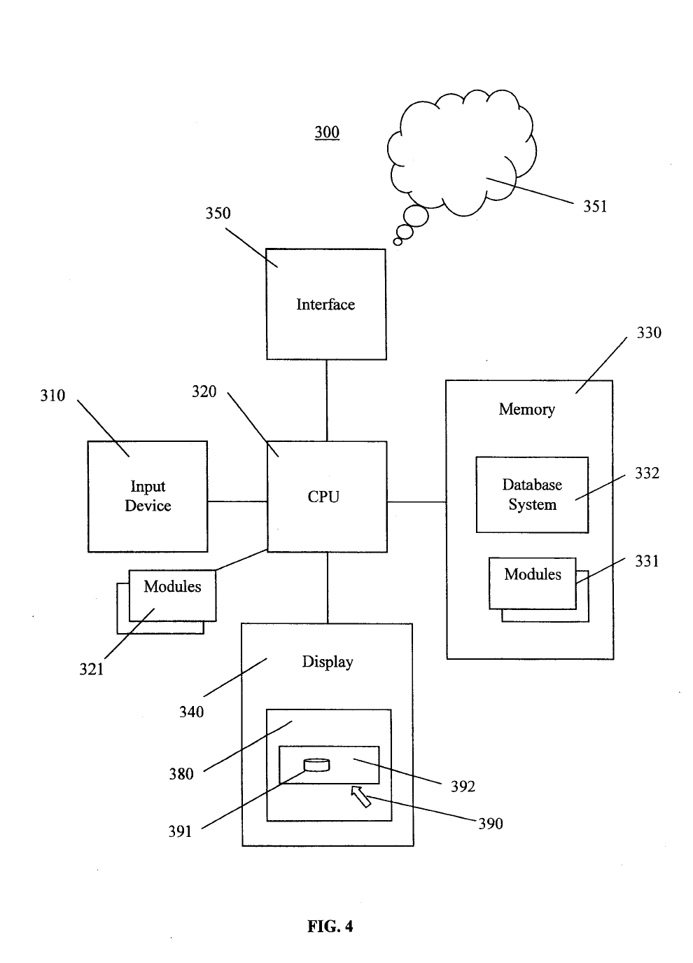

FIG. 3 is a block diagram illustrating a deployment structure 400 for the architecture 200 of FIG. 2 in accordance with an embodiment of the application. FIG. 3 shows how the various components of the solar power forecasting system's architecture 200 relate to the execution environments and hardware that support it. The deployment structure 400 closely mirrors the architecture 200 of FIG. 2. The web server (e.g., 300 in FIG. 4) hosts the presentation and service tiers. It may operate in a Linux™ environment that has access to the database through Java™ database connectivity (“JDBC”), and access to mount points on the network storage drive through the Samba™ protocol. The web application hosted in Tomcat™ 7 is made available to the standard HTTP port (80) using a Tomcat™ connector plugin for the Apache™ web server. The database and network storage drive host the data tier. The database management system may be MySQL™ 5.5 or an equivalent version of MariaDB™. It is populated with the solar forecasting data model. The database must grant appropriate permissions to the web server and application server (e.g., 300 in FIG. 4). The application server and Linux™ cluster correspond to the back-end procedures tier. As the solar power forecasting scripts are Windows™ compatible, the application server must likewise be a Windows™ environment. It uses Windows™ file sharing to access the solar forecasting system's shared directories. The Linux™ cluster hosts the local area forecasting system (“LAPS”) and the weather research and forecasting (“WRF”) model, and makes use of shared network storage to deliver its data to the solar forecasting system 100.

FIG. 4 is a block diagram illustrating a data processing system 300 in accordance with an embodiment of the invention. The data processing 300 is suitable for performing as a solar power forecasting system 100 or as various components in the architecture 200 thereof (e.g., web server, application server, etc.), a control system, supervisory control and data acquisition (“SCADA”) system, energy management system (“EMS”), or the like. The data processing system 300 is also suitable for data processing, management, storage, and for generating, displaying, and adjusting presentations in conjunction with a user interface or a graphical user interface (“GUI”), as described below. The data processing system 300 may be a client and/or server in a client/server system (e.g., 100). For example, the data processing system 300 may be a server system or a personal computer (“PC”) system. The data processing system 300 may also be a distributed system which is deployed across multiple processors. The data processing system 300 may also be a virtual machine. The data processing system 300 includes an input device 310, at least one central processing unit (“CPU”) 320, memory 330, a display 340, and an interface device 350. The input device 310 may include a keyboard, a mouse, a trackball, a touch sensitive surface or screen, a position tracking device, an eye tracking device, a camera, a tactile glove or gloves, a gesture control armband, or a similar device. The display 340 may include a computer screen, a television screen, a display screen, a terminal device, a touch sensitive display surface or screen, a hardcopy producing output device such as a printer or plotter, a head-mounted display, virtual reality (“VR”) glasses, an augmented reality (“AR”) display, a hologram display, or a similar device. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., similar to data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). As such, the interface 350 may include suitable transmitters, receivers, antennae, etc. Thus, the data processing system 300 may be linked to other data processing systems by the network 351. In addition, the interface 351 may include one or more input and output connections or points for connecting various sensors, status (indication) inputs, analog (measured value) inputs, counter inputs, analog outputs, and control outputs to the data processing system 300. In addition, the data processing system 300 may include a Global Positioning System (“GPS”) receiver. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user commands, queries, or data and to the display 340 for displaying the results of these commands, queries, or data to the user. Commands, queries, and data may also be received via the interface device 350 and results and data may be transmitted via the interface device 350. The data processing system 300 may include a data store or database system 332 for storing data and programming information. The database system 332 may include a database management system (e.g., 332) and a database (e.g., 332) and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the application.

Thus, the data processing system 300 includes computer executable programmed instructions for directing the system 300 to implement the embodiments of the present application. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium or product (e.g., one or more digital video disks (“DVDs”), compact disks (“CDs”), memory sticks, etc.) which may be used for transporting the programmed instructions to the memory 330 of the data processing system 300. Alternatively, the programmed instructions may be embedded in a computer-readable signal or signal-bearing medium or product that is uploaded to a network 351 by a vendor or supplier of the programmed instructions, and this signal or signal-bearing medium or product may be downloaded through an interface (e.g., 350) to the data processing system 300 from the network 351 by end users or potential buyers.

A user may interact with the data processing system 300 and its hardware and software modules 321, 331 using a user interface such as a graphical user interface (“GUI”) 380 (and related modules 321, 331). The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by selecting or “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

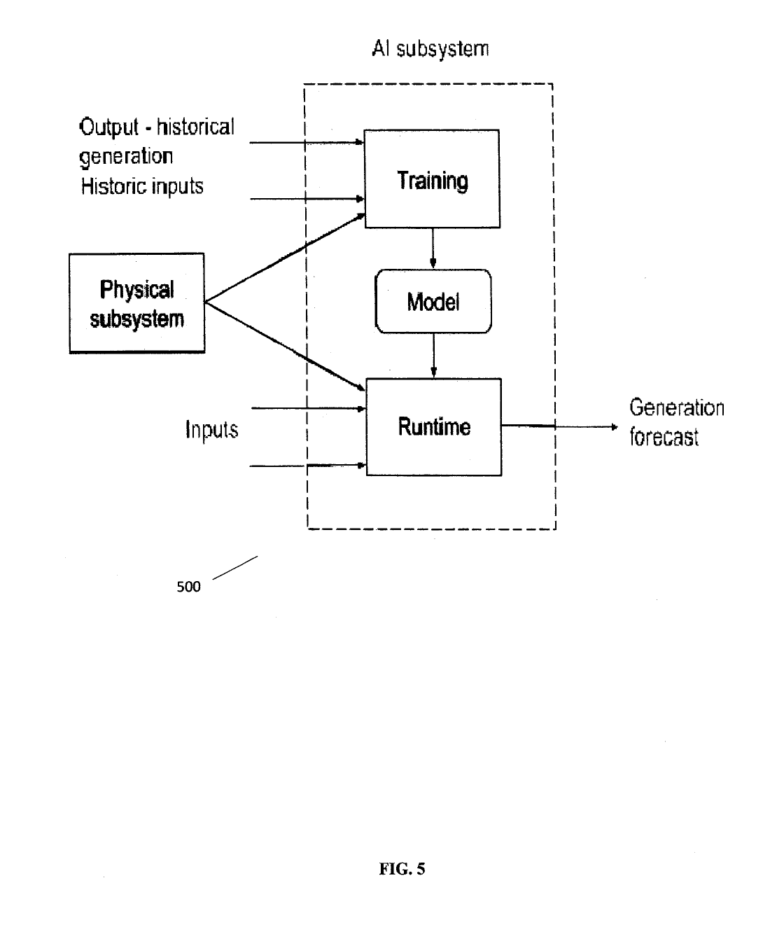

FIG. 5 is a block diagram illustrating a hybrid physical and AI system 500 for solar power forecasting in accordance with an embodiment of the application. According to one embodiment of the present application, there is provided a PV generation forecasting system 100 that implements a novel hybrid approach to orchestrating physical and artificial intelligence (“AI”) systems or subsystems 500. The physical subsystem implements WRF and other numerical weather prediction models, satellite imagery processing models, cloud tracking models and solar power plant models and may include other physical model components. The AI subsystem 500 implements autoregressive integrated moving average (“ARIMA”), regression and other statistical methods and AI methods including artificial neural networks (“ANN”), support vector machines (“SVM”) and others. FIG. 5 illustrates the hybrid architecture of the present application. Project specific method selection is done during model validation to improve forecasting accuracy. Outputs from the physical subsystem serve as AI subsystem inputs. Other AI subsystem inputs may include measured generation, measured and forecast weather, and other operational parameters. During the training process historical inputs and PV power generation outputs are used to train the model. A trained model is used at runtime to produce a generation forecast based on the inputs from physical subsystems as well as other parameters. Specifically, in runtime at any time T₀, the method of the present application uses observed data at T₀ and forecasts from physical models at T₀ for forecast horizon T₁ to produce the final forecast for T₁.

With respect to forecast horizons and forecast accuracy, the major forecast horizons established by the industry include:
a) Day-ahead horizon (“DA”), typically 72 hours ahead and sometimes up to 168 hours ahead;
b) Hour-ahead horizon (“HA”), typically 3 hours ahead and sometimes up to 6 hours ahead; and,
c) Intra-hour horizon (“IH”), typically 5-minute temporal resolution 15 minutes ahead.

Forecast accuracy is generally defined by such metrics as mean bias, mean absolute error, and root mean square error.

Forecast accuracy at different forecast horizons strongly depends on the forecast methods and models used. However, for a balanced combination of physical and statistical forecasting models it is expected that forecast accuracy is correlated with forecast horizons and is higher at shorter horizons and lower at longer time horizons.

Other factors having an impact on forecast accuracy include solar microclimatology, intra-day, and intra-hour intermittency of cloudiness and related ramp rates.

Naïve forecasts produced by the system 100, 500 provide a benchmark for the physical and statistical methods. Generally, a naive forecast produces results equal to the last observed data. Since PV generation has a well pronounced seasonality, the naive forecast accounts for this. The prediction value is set to yesterday's same time of the day observed value.

Forecast model training and calibration with historically observed data in accordance with embodiments of the present application will be described in the following in terms of: hindcasting (or retrospective forecasting) as a means for model training and calibration; selected numerical weather predictions for hindcasting; systematic error compensation; and, forecast performance and forecast accuracy guarantees.

Hindcasting as a Means for Model Training and Calibration. According to one embodiment, hindcasting is used as a means for model training and calibration. “Hindcasting” implies that both historical inputs for forecasting models and as well as observed solar power generation data are available for producing forecasts for time horizons in the past. For example, all data inputs required by physical models at noon on Jan. 1, 2014 and observed solar power generation data both at noon on Jan. 1, 2014 and on Jan. 2, 2014 is made available to produce a day-ahead forecast post-labeled, for example, “noon Jan. 1, 2014” and to validate its accuracy.

Availability of historical data both for model inputs and observed generation outputs allows the system to better train and calibrate hybrid forecasting models. It also allows for the making of improved decisions with respect to expected accuracy of forecasting in real time.

Selected Numerical Weather Predictions for Hindcasting. Different physical forecasting models feature different levels of complexity and as a result these models require different periods of time to run. While this may not be a problem in real time, it may create a technical challenge for hindcasting when forecast data time series have to be produced for a whole selected forecast period. This is especially applicable to using high resolution WRF numerical weather prediction (“NWP”) models. To deal with this issue, an optimal NWP source and model should be selected to meet the calculation time constraints while meeting the target forecast accuracy.

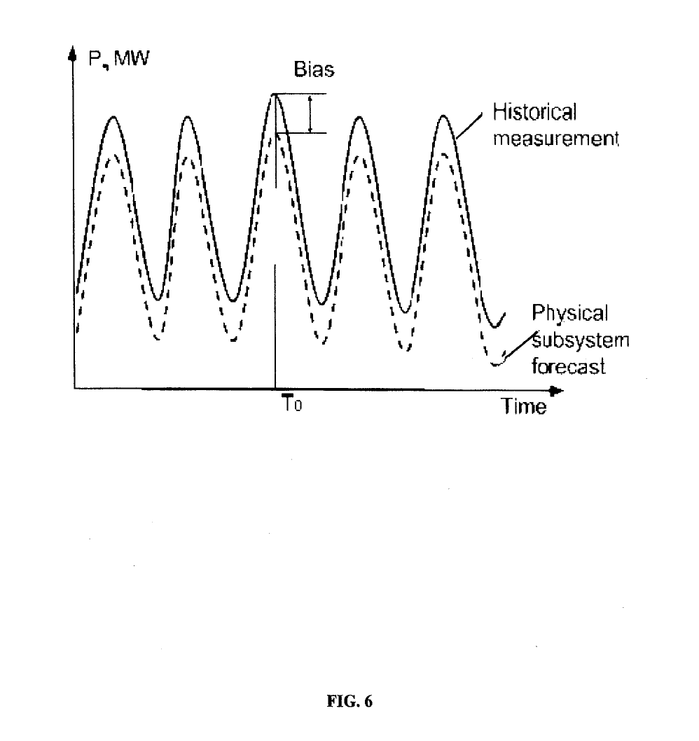

Systematic Error Compensation. FIG. 6 is a graph illustrating AI model training to compensate for physical model bias in accordance with an embodiment of the application. With respect to bias compensation, the AI subsystem 500 compares generation forecasts with generation measurements over the training period to train the models thus yielding lower systematic errors, also known as forecast bias. From Wikipedia™, one definition of forecast bias is as follows: “A forecast bias occurs when there are consistent differences between actual outcomes and previously generated forecasts of those quantities; that is: forecasts may have a general tendency to be too high or too low. A normal property of a good forecast is that it is not biased”. FIG. 6 illustrates bias compensation training for an AI model. Historical generation measurements are used as the outputs and physical subsystem forecasts are used as the inputs to train the model. The model will learn the bias and compensate for the bias at runtime.

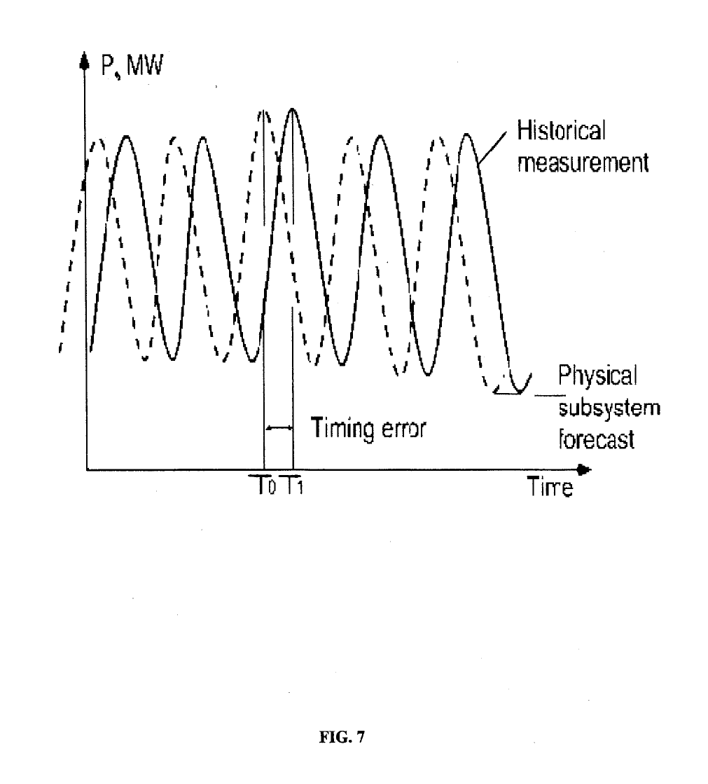

FIG. 7 is a graph illustrating AI model training to compensate for physical model timing error in accordance with an embodiment of the application. With respect to timing error compensation, the physical models can produce timing errors when, for example, forecast ramp-up, peak, ramp-down, and nadir lag behind the measurements. The system 100, 500 compares generation forecasts with the measurements to train the models thus yielding lower timing error. FIG. 7 illustrates timing error compensation training for an AI model. Note that physical subsystem forecasts lag behind generation measurements. Historical generation measurement at time T₀ is used as the output to train the AI model. Physical subsystem forecasts at various time horizons are used among other inputs. In general, a physical forecast can lag or lead observed data and therefore multiple physical forecasts are used centered on To. The model will learn the timing error comparing errors between the measurements and the forecasts and compensate for this error at runtime.

With respect to compensation extrapolation, the physical models' forecast bias and timing error can change over time. For example, forecast bias can be positive or higher during one season and negative or lower during another season. Similarly, a forecast can lag behind measurements during a certain period of time and be in advance of measurements during another time period exposing a variable timing error. To minimize the error caused by this behavior, the system 100, 500 optimizes the training time period. The training period is selected to be short enough to have a similar forecast bias and timing error, and long enough to include all necessary information for model training. In addition, during runtime, forecast errors are continuously monitored and if the error increases due to changes in forecast bias, timing error or other reason, the AI model is retrained with the data with the same statistical properties and this model is used in forecasting. Furthermore, time of the day and seasonality information may be included in the model training. In this case, the AI model can extrapolate adapting to changing forecast bias and timing error during runtime based on the execution data and time.

With respect to missing data imputation, when training models the system 100, 500 uses various methods of imputation, filling in the gaps in the data with suitable replacements.

Forecast Performance and Forecast Accuracy Guarantees. Hindcasting is an ideal tool to assess expected performance of a forecast system and the forecast accuracy in advance of starting operational forecasting for client facilities. It also provides an opportunity to provide clients with a forecast accuracy guarantee statement. Forecast accuracy is continuously monitored. Variable statistical properties may affect forecast accuracy. If the forecast error increases above a certain limit or threshold, the system 100, 500 announces this by sending a text message or email to an authorized operator. The operator then may retrain statistical models based on recent data.

Operating forecasting in runtime in accordance with embodiments of the present application will be described in the following in terms of: physical model selection for different forecast horizons; refining forecast accuracy by artificial intelligence methods; and, missing data imputation in runtime.

Physical Models Selection for Different Forecast Horizons. Is it has been shown by industry practice that different forecast horizons benefit more from different physical forecast models. Day ahead forecasts are improved when they rely on numerical weather prediction models or ensembles of those. Hour ahead forecasts perform better when satellite imagery processing and cloud tracking models are used. Intra-hour forecasts may also rely heavily on satellite-derived data and cloud tracking.

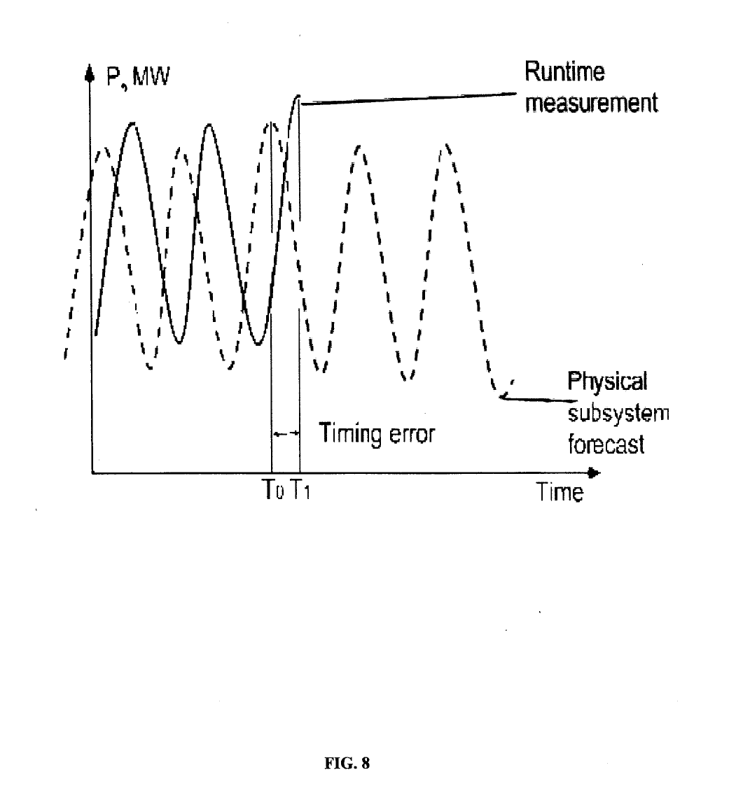

Refining Forecast Accuracy by Artificial Intelligence Methods. FIG. 8 is a graph illustrating AI physical model refining in accordance with an embodiment of the application. Physical model error may be caused by erroneous cloud geographical position and/or timing errors. At runtime, the AI system 500 may use measurements to refine physical forecasts. FIG. 8 illustrates forecast refining. At runtime, the AI model compares a physical subsystem forecast with the measurements to compensate for value and timing errors. This strategy provides better results for shorter horizons.

The measurements may include values at runtime and multiple past values. For example, a 15 minute ahead forecast produced at time T₀ may include the measurements at this time T₀ and 15, 30, 45 and 60 minutes prior to it. Input selection may be performed to improve forecasting accuracy.

Missing Data Imputation in Runtime. If data is missing at runtime, the system 100, 500 may produce a forecast based on the present data for different horizons. For example, if data at time T₁ necessary to produce a forecast at time T_{f} for horizon Tₕ is missing, the AI subsystem 500 may substitute this forecast with the forecast based on data preceding T₁ with the longer horizon.

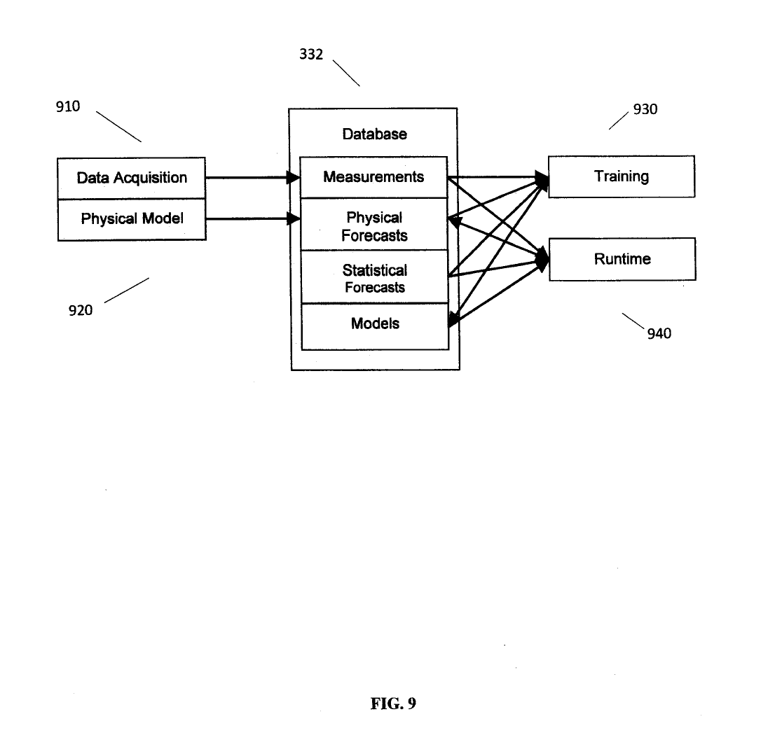

FIG. 9 is a flow diagram illustrating data flows within the solar power forecasting system 100 in accordance with an embodiment of the application. The database (e.g., 332) serves as a system central repository. The database 332 includes areas to store measurements, forecasts, models and other information. The data acquisition subsystem 910 acquires current and historical measurements from supervisory control and data acquisition (“SCADA”) systems, energy management systems (“EMS”), remote terminal units (“RTU”), databases or similar devices and stores these measurements in the measurements database. These measurements include ambient temperatures, global horizontal irradiance, power flows, and other measurements. Moreover, the data acquisition subsystem 910 acquires and stores in the forecasts database weather forecasts including ambient temperature, global horizontal irradiance, and other forecasts. The physical model 920 module or system stores generation forecasting results in the forecasts database. The forecasts may include PV generation for various horizons.

According to one embodiment, training may be performed in manual and/or automatic modes. In the manual mode, an analyst or user fetches the measurements and physical forecasts. The datasets are separated into two parts, namely, one for training and another for validation. The analyst creates a model using a training subset. After the model is created, its performance is validated with the validation data subset. After the training and validation iterative process is complete, the analyst saves the trained model 930 into the models database. In automatic mode, statistical models are trained and validated in batches. The operator or user may review the results written in various log files. In the runtime mode 940, the calculation engine fetches measurements, physical forecasts, and models from the database, produces a generation forecast, and stores it in the statistical forecasts database.

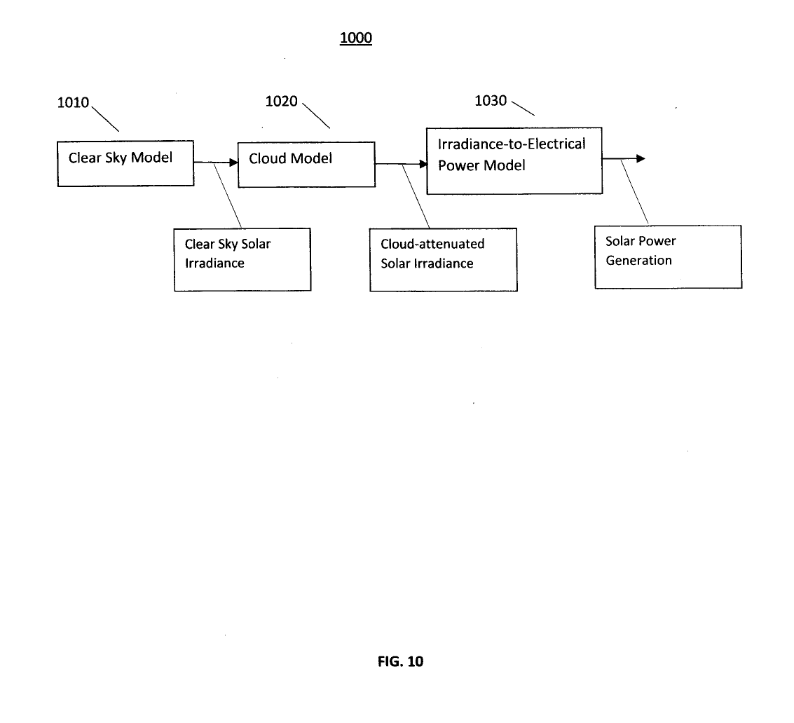

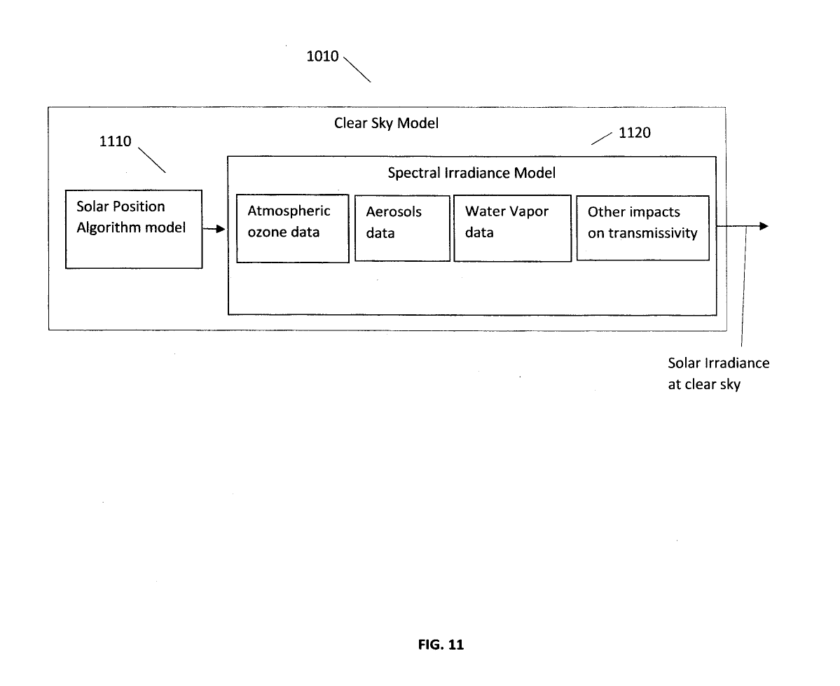

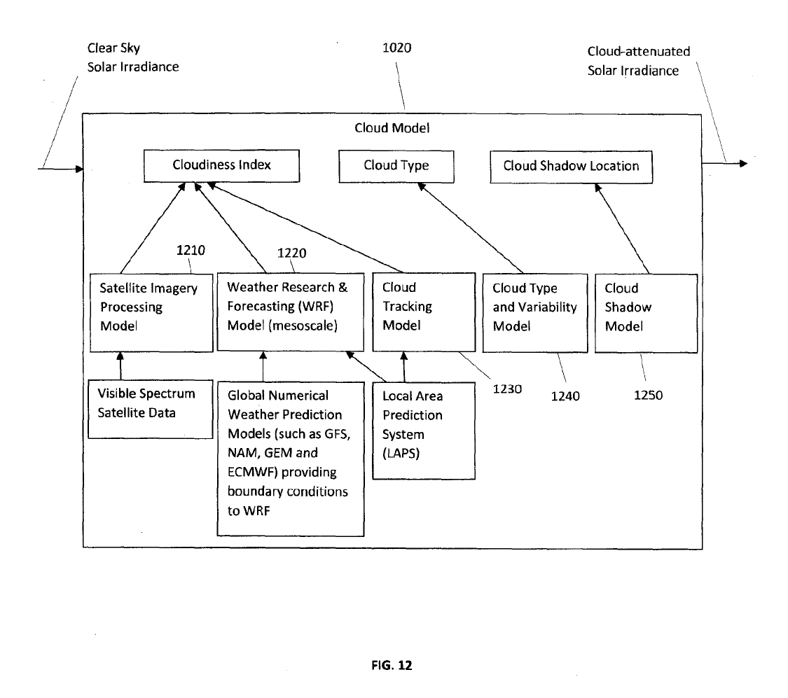

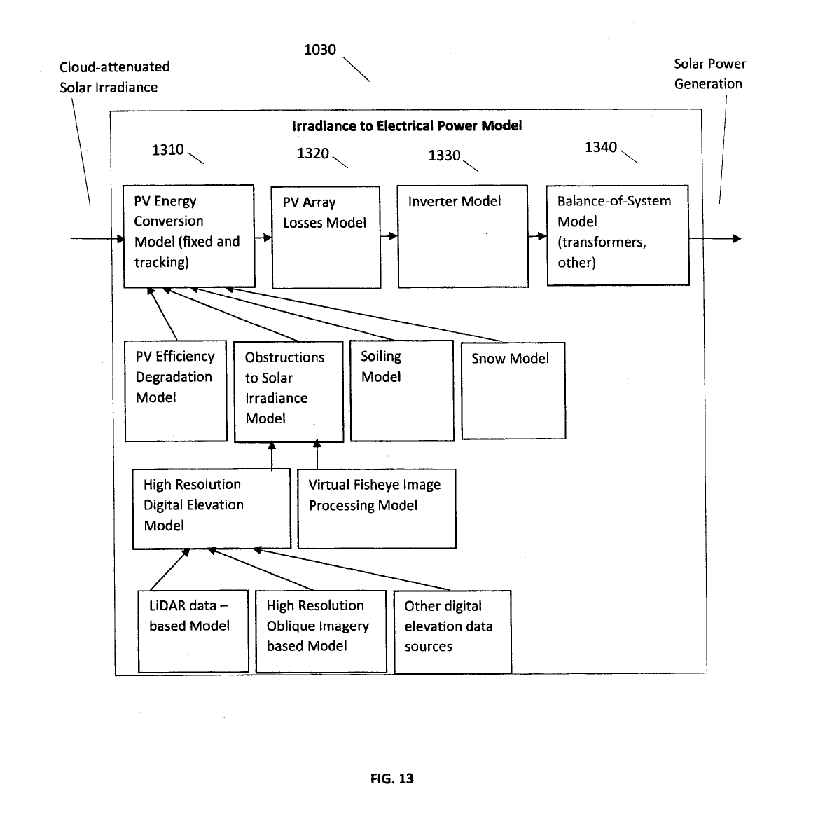

FIG. 10 is a flow diagram illustrating data flows 1000 between physical models 920 within the solar power forecasting system 100 in accordance with an embodiment of the application. FIG. 11 is a flow diagram illustrating data flows within the clear sky model 1010 of FIG. 10 in accordance with an embodiment of the application. FIG. 12 is a flow diagram illustrating data flows within the cloud model 1020 of FIG. 10 in accordance with an embodiment of the application. And, FIG. 13 is a flow diagram illustrating data flows within the irradiance-to-electrical power model 1030 of FIG. 10 in accordance with an embodiment of the application.

According to one embodiment, the solar power generation model of the present application includes a clear sky model 1010, a cloud model 1020, and an irradiance-to-electrical power model 1030 as shown in FIG. 10. The output of the clear sky model 1010 is solar irradiance in clear sky conditions; the output of cloud model 1020 is solar irradiance after the impact of clouds has been considered; and, the output of the irradiance-to-electrical power model 1030 is solar power generation. Each of these models 1010, 1020, 1030 includes the model inputs shown in FIGS. 11, 12, and 13, respectively.

Referring to FIG. 11, the clear sky model 1010 includes a solar position algorithm model 1110 and a spectral irradiance model 1120 as two major components.

Referring to FIG. 12, the cloud model 1020 includes a satellite imagery processing model 1210 which defines the location of clouds, WRF 1220 and cloud tracking 1230 models which define the future position of the clouds based on the speed and direction of cloud movement, a cloud type and variability model 1240, and a cloud shadow model 1250 both of which define “filtering” characteristics for solar irradiance attenuation.

With respect to the cloud type and variability model (or module) 1240, the amount of light transmitted through the atmosphere depends on the amount of clouds (i.e., the cloud index) and their type. The model 1240 considers at least ten (10) types of clouds as follows: stratus, nimbostratus, stratocumulus, cumulus, cumulonimbus, altostratus, altocumulus, cirrostratus, cirrocumulus, and cirrus. Each type of cloud has characteristic properties. Because of varying cloud properties, the cloud cover alone is generally insufficient for the estimation of passing irradiance. Optical thickness of a cloud is the most important parameter for describing cloud shortwave radiative properties. It is a measure of the attenuation of the light passing through the atmosphere due to scattering and absorption by cloud droplets. The model 1240 operates as follows. First, the model obtains information from WRF with respect to cloud location, top, and base pressures. Second, based on the foregoing, the model 1240 classifies clouds into one of the ten classes described above to determine a cloud type. Third, the model 1240 applies an attenuation coefficient to the previously calculated clear sky GHI, based on a lookup table of optical thicknesses for different cloud types.

With respect to the cloud shadow model (or module) 1250, in most meteorological studies it is assumed that clouds detected in satellite images or modeled in NWP cast shadows directly beneath them at all times. The same applies to cloud cover used in WRF solar irradiance modeling. For datasets where each cell/pixel size for a region of interest equates to 10 km² or more, this assumption is generally true, however, the shift in location of shadows on the ground increases with smaller cell sizes, larger zenith angles, and with higher cloud altitudes. The cloud shadow model 1250 accurately calculates the position of cloud shadows using WRF/LAPS cloud cover data as follows. First, the cloud cover data is exported from WRF as a comma separated values (“CSV”) file. Second, based on the metadata file, the model reads or receives the following variables: (1) year, month, day, time, time zone; (2) rows, columns—number of rows/columns of data cells in one pressure level table; (3) tables—number of data tables; (4) data gaps—number of skipped rows in CSV prior to start of each consecutive table; and, (5) grid resolution—resolution of each grid cell in meters. Third, cloud, elevation, latitude, and longitude tables are imported from WRF. The lowest pressure table is at ground level, representing the terrain's digital elevation model (“DEM”). Fourth, general solar geometry calculations are performed based on the metadata. Fifth, solar geometry components are calculated for each map cell based on the general solar geometry and latitude/longitude of each cell of the region. Sixth, for each cell, the locations of shadows that fall on a flat surface are calculated. Seventh, for each cell, the locations of shadows that fall on the DEM surface are calculated. This shows the true position of the shadows on the terrain for the region of interest (e.g., the region about or surrounding a solar power plant) and is used for the final output. Eighth, locations of shadows are exported to a CSV file and are used for calculating the cloud index.

Referring to FIG. 13, the irradiance-to-electrical power model 1030 depends on the solar power conversion technology used by the solar power plant such as solar PV, concentrating PV, or concentrating solar thermal. For example, the solar PV irradiance-to-electrical power model 1030 may include four major components as follows: a PV energy conversion model (fixed, one axis and two-axis array tracking) 1310, a PV array losses model 1320, an inverter model 1330, and a balance-of-system model (transformer and other losses) 1340. The PV energy conversion model 1310 includes a PV efficiency degradation model describing natural reduction in efficiency of solar PV cells over time, a soiling model describing reduction in efficiency of solar cells due to soiling of their surfaces, a snow model describing reduction in efficiency of PV panels due to full or partial snow cover, and an obstructions to solar irradiance model. The obstructions to solar irradiance model includes two major components as follows: a high resolution digital elevation model defining obstructions to irradiance from natural or man-made obstructions (e.g., hills, trees, neighbouring buildings, etc.) and a virtual fisheye image processing model for calculating the “filtering” impact of obstructions on available solar irradiance. The high resolution digital elevation model includes several sources of digital elevation data such as a LiDAR data-based model, a high resolution oblique imagery based model, and other sources.

Referring to FIGS. 5 to 13, according to one embodiment, a solar power forecast may be generated for a solar power plant as follows.

First, with respect to training 930, the following steps may be performed:
a) select a training period of time, daily forecast production schedule, and forecast horizon(s);
b) read historical outputs such as generation;
c) read historical inputs such as physical subsystem generation forecasts and other inputs;
d) visually inspect the data set, test for outliers, missing data, and other data defects;
e) remove and/or replace bad quality data;
f) apply data pre-processing including filtering, wavelet transforms, or other techniques;
g) split acquired data set into a training subset and a testing subset;
h) train AI model with the training subset;
i) use trained model to produce forecasts from the testing subset;
j) validate model performance by comparing forecasts with the testing subset outputs and applying statistical measures such as mean absolute error (“MAE”), mean absolute percent error (“MAPE”), or others;
k) adjust model inputs, data pre-processing, model configuration, and/or training algorithms and repeat the training steps until a satisfactory performing model is built; and,
l) save the model.

Second, with respect to run-time 940, the following steps may be performed:
a) read current inputs such as physical subsystem generation forecasts and other inputs for a selected forecast horizon;
b) apply data pre-processing;
c) read trained model;
d) produce generation forecasts; and,
e) store the forecasts in the database 332.

In the above, with respect to the production of historical inputs from physical subsystem generation forecasts for training 930, for each forecast production time during the selected training period according to forecast production schedule and selected forecast horizon(s), the following steps may be performed:
a) run the clear sky model 1010 and produce global horizontal irradiance (“GHI”) data at clear sky;
b) run a cloudiness index/clearness index model to produce cloudiness index data;
c) run the cloud model 1020 using the GHI data at clear sky and the cloudiness index data to produce cloud-attenuated global irradiance data at the plane of array (“POA”);
d) run an obstructions to solar irradiance model to calculate the impact of obstructions on available global irradiance at the plane of array;
e) run the PV energy conversion model (fixed or tracking) 1310 to calculate solar power production by individual PV modules; and,
f) run PV array losses, inverter, and balance-of-system models 1320, 1330, 1340 to produce a solar power generation forecast for the solar power plant.

Also in the above, with respect to production of physical subsystem generation forecasts in runtime 940, for a selected forecast horizon, the following steps may be performed:
a) run the clear sky model 1010 and produce global horizontal irradiance (“GHI”) data at clear sky;
b) run the cloudiness index/clearness index model to produce cloudiness index data;
c) run the cloud model 1020 using the GHI at clear sky and the cloudiness index data to produce cloud-attenuated global irradiance data at the plane of array;
d) select an obstruction factor to calculate the impact of obstructions on available global irradiance at the plane of array;
e) run PV energy conversion model (fixed or tracking) 1310 to calculate solar power production by individual PV modules; and,
f) run PV array losses, inverter, and balance-of-system models 1320, 1330, 1340 to produce the solar power generation forecast for solar power plant.

Aspects of the above described methods and systems may be summarized with the aid of a flowchart.

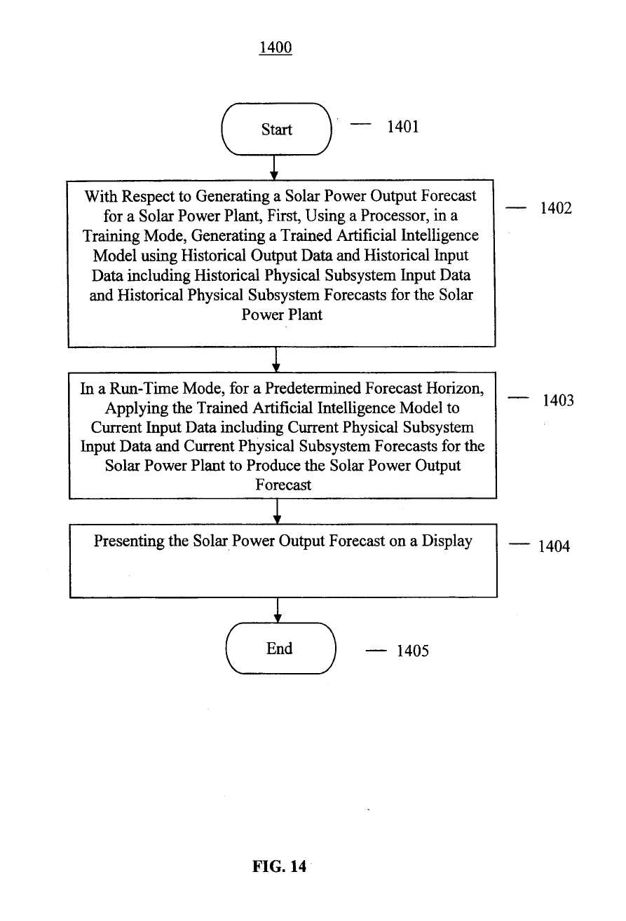

FIG. 14 is a flow chart illustrating operations 1400 of modules (e.g., 331) within a data processing system (e.g., 300) for generating a solar power output forecast for a solar power plant, in accordance with an embodiment of the application.

At step 1401, the operations 1400 start.

At step 1402, using a processor 320, in a training mode 930, a trained artificial intelligence model is generated using historical output data and historical input data including historical physical subsystem input data and historical physical subsystem forecasts for the solar power plant.

At step 1403, in a runtime mode 940, for a predetermined forecast horizon, the trained artificial intelligence model is applied to current input data including current physical subsystem input data and current physical subsystem forecasts for the solar power plant to produce the solar power output forecast.

At step 1404, the solar power output forecast is presented on a display 340.

At step 1405, the operations 1400 end.

The above method may further include generating the historical physical subsystem forecasts using the historical input data by: determining a global horizontal irradiance (“GHI”) value at clear sky 1010; determining a cloudiness index, a cloud shadow location, and a cloud type; determining a cloud-attenuated global irradiance at a plane of array of the solar power plant from the clear sky GHI value, the cloudiness index, the cloud shadow location, and the cloud type 1020; determining an impact of obstructions on available global irradiance at the plane of array of the solar power plant; determining solar power production by individual photovoltaic (“PV”) modules of the solar power plant 1310; and, determining PV array, inverter, and balance-of-system losses of the solar power plant 1320, 1330, 1340. The method may further include generating the current physical subsystem forecasts using the current input data by: determining a global horizontal irradiance (“GHI”) value at clear sky 1010; determining a cloudiness index, a cloud shadow location, and a cloud type; determining a cloud-attenuated global irradiance at a plane of array of the solar power plant from the clear sky GHI value, the cloudiness index, the cloud shadow location, and the cloud type 1020; determining an impact of obstructions on available global irradiance at the plane of array of the solar power plant; determining solar power production by individual photovoltaic (“PV”) modules of the solar power plant 1310; and, determining PV array, inverter, and balance-of-system losses of the solar power plant 1320, 1330, 1340. The method may further include determining the cloud shadow location 1250 by: receiving cloud cover data from a weather research and forecasting (“WRF”) model, the cloud cover data including cloud elevation, latitude, and longitude data for a region in which the solar power plant is located; calculating solar geometry values from the cloud elevation, latitude, and longitude data to determine locations of shadows that fall on a flat surface for the region; and, determining locations of shadows that fall on a digital elevation model (“DEM”) surface for the region from the locations of shadows that fall on the flat surface for the region. The method may further include subdividing the region into one or more cells and determining the cloud shadow location for each of the one or more cells. The method may further include determining the cloud type for the cloud 1240 by: obtaining cloud location, top, and base pressure information for a cloud from a weather research and forecasting (“WRF”) model; and, using the cloud location, top, and base pressure information for the cloud to look up the cloud type in a cloud classification table. The cloud classification table may include entries for a predetermined number of cloud types. The predetermined number of cloud types may be ten and the cloud classification table may include entries for stratus, nimbostratus, stratocumulus, cumulus, cumulonimbus, altostratus, altocumulus, cirrostratus, cirrocumulus, and cirrus cloud types. The method may further include receiving the historical output data and the historical input data including the historical physical subsystem input data and the historical physical subsystem forecasts for the solar power plant from a database 332. And, the method may further include receiving the current input data including the current physical subsystem input data and the current physical subsystem forecasts for the solar power plant from a data acquisition system 910 coupled to the solar power plant.

According to one embodiment, each of the above steps 1401-1405 may be implemented by a respective software module 331. According to another embodiment, each of the above steps 1401-1405 may be implemented by a respective hardware module 321. According to another embodiment, each of the above steps 1401-1405 may be implemented by a combination of software 331 and hardware modules 321. For example, FIG. 14 may represent a block diagram illustrating the interconnection of specific hardware modules 1401-1405 (collectively 321) within the data processing system or systems 300, each hardware module 1401-1405 adapted or configured to implement a respective step of the method of the application.

While this application is primarily discussed as a method, a person of ordinary skill in the art will understand that the apparatus discussed above with reference to a data processing system 300 may be programmed to enable the practice of the method of the application. Moreover, an article of manufacture for use with a data processing system 300, such as a pre-recorded storage device or other similar computer readable medium or computer program product including program instructions recorded thereon, may direct the data processing system 300 to facilitate the practice of the method of the application. It is understood that such apparatus, products, and articles of manufacture also come within the scope of the application.

In particular, the sequences of instructions which when executed cause the method described herein to be performed by the data processing system 300 may be contained in a data carrier product according to one embodiment of the application. This data carrier product may be loaded into and run by the data processing system 300. In addition, the sequences of instructions which when executed cause the method described herein to be performed by the data processing system 300 may be contained in a computer software product or computer program product (e.g., comprising a non-transitory medium) according to one embodiment of the application. This computer software product or computer program product may be loaded into and run by the data processing system 300. Moreover, the sequences of instructions which when executed cause the method described herein to be performed by the data processing system 300 may be contained in an integrated circuit product (e.g., a hardware module or modules 321) which may include a coprocessor or memory according to one embodiment of the application. This integrated circuit product may be installed in the data processing system 300.

The embodiments of the application described above are intended to be examples only. Those skilled in the art will understand that various modifications of detail may be made to these embodiments, all of which come within the scope of the application.

What is claimed is:

1. A method for generating a solar power output forecast for a solar power plant, comprising:
using a processor, in a training mode, generating a trained artificial intelligence model using historical output data and historical input data including historical physical subsystem input data and historical physical subsystem forecasts for the solar power plant;
in a runtime mode, for a predetermined forecast horizon, applying the trained artificial intelligence model to current input data including current physical subsystem input data and current physical subsystem forecasts for the solar power plant to produce the solar power output forecast; and,
presenting the solar power output forecast on a display.

2. The method of claim 1, further comprising generating the historical physical subsystem forecasts using the historical input data by:
determining a global horizontal irradiance (“GHI”) value at clear sky;
determining a cloudiness index, a cloud shadow location, and a cloud type;
determining a cloud-attenuated global irradiance at a plane of array of the solar power plant from the clear sky GHI value, the cloudiness index, the cloud shadow location, and the cloud type;
determining an impact of obstructions on available global irradiance at the plane of array of the solar power plant;
determining solar power production by individual photovoltaic (“PV”) modules of the solar power plant; and,
determining PV array, inverter, and balance-of-system losses of the solar power plant.

3. The method of claim 2, further comprising generating the current physical subsystem forecasts using the current input data by:
determining a global horizontal irradiance (“GHI”) value at clear sky;
determining a cloudiness index, a cloud shadow location, and a cloud type;
determining a cloud-attenuated global irradiance at a plane of array of the solar power plant from the clear sky GHI value, the cloudiness index, the cloud shadow location, and the cloud type;
determining an impact of obstructions on available global irradiance at the plane of array of the solar power plant;
determining solar power production by individual photovoltaic (“PV”) modules of the solar power plant; and,
determining PV array, inverter, and balance-of-system losses of the solar power plant.

4. The method of claim 3, further comprising determining the cloud shadow location by:
receiving cloud cover data from a weather research and forecasting (“WRF”) model, the cloud cover data including cloud elevation, latitude, and longitude data for a region in which the solar power plant is located;
calculating solar geometry values from the cloud elevation, latitude, and longitude data to determine locations of shadows that fall on a flat surface for the region; and, determining locations of shadows that fall on a digital elevation model (“DEM”) surface for the region from the locations of shadows that fall on the flat surface for the region.

5. The method of claim 4, further comprising subdividing the region into one or more cells and determining the cloud shadow location for each of the one or more cells.

6. The method of claim 3, further comprising determining the cloud type for the cloud by:
obtaining cloud location, top, and base pressure information for a cloud from a weather research and forecasting (“WRF”) model; and,
using the cloud location, top, and base pressure information for the cloud to look up the cloud type in a cloud classification table.

7. The method of claim 6, wherein the cloud classification table includes entries for a predetermined number of cloud types.

8. The method of claim 7, wherein the predetermined number of cloud types is ten and wherein the cloud classification table includes entries for stratus, nimbostratus, stratocumulus, cumulus, cumulonimbus, altostratus, altocumulus, cirrostratus, cirrocumulus, and cirrus cloud types.

9. The method of claim 1, further comprising receiving the historical output data and the historical input data including the historical physical subsystem input data and the historical physical subsystem forecasts for the solar power plant from a database.

10. The method of claim 1, further comprising receiving the current input data including the current physical subsystem input data and the current physical subsystem forecasts for the solar power plant from a data acquisition system coupled to the solar power plant.

11. A system for generating a solar power output forecast for a solar power plant, comprising:
a processor coupled to memory and a display; and,
at least one of hardware and software modules within the memory and controlled or executed by the processor, the modules including:
a module adapted to, in a training mode, generate trained artificial intelligence model using historical output data and historical input data including historical physical subsystem input data and historical physical subsystem forecasts for the solar power plant;
a module adapted to, in a runtime mode, for a predetermined forecast horizon, apply the trained artificial intelligence model to current input data including current physical subsystem input data and current physical subsystem forecasts for the solar power plant to produce the solar power output forecast; and,
a module adapted to present the solar power output forecast on a display.

12. The system of claim 11, further comprising a module adapted to generate the historical physical subsystem forecasts using the historical input data by:
determining a global horizontal irradiance (“GHI”) value at clear sky;
determining a cloudiness index, a cloud shadow location, and a cloud type;
determining a cloud-attenuated global irradiance at a plane of array of the solar power plant from the clear sky GHI value, the cloudiness index, the cloud shadow location, and the cloud type;
determining an impact of obstructions on available global irradiance at the plane of array of the solar power plant;
determining solar power production by individual photovoltaic (“PV”) modules of the solar power plant; and,
determining PV array, inverter, and balance-of-system losses of the solar power plant.

13. The system of claim 12, further comprising a module adapted to generate the current physical subsystem forecasts using the current input data by:
determining a global horizontal irradiance (“GHI”) value at clear sky;
determining a cloudiness index, a cloud shadow location, and a cloud type;
determining a cloud-attenuated global irradiance at a plane of array of the solar power plant from the clear sky GHI value, the cloudiness index, the cloud shadow location, and the cloud type;
determining an impact of obstructions on available global irradiance at the plane of array of the solar power plant;
determining solar power production by individual photovoltaic (“PV”) modules of the solar power plant; and,
determining PV array, inverter, and balance-of-system losses of the solar power plant.

14. The system of claim 13, further comprising a module adapted to determine the cloud shadow location by:
receiving cloud cover data from a weather research and forecasting (“WRF”) model, the cloud cover data including cloud elevation, latitude, and longitude data for a region in which the solar power plant is located;
calculating solar geometry values from the cloud elevation, latitude, and longitude data to determine locations of shadows that fall on a flat surface for the region; and,
determining locations of shadows that fall on a digital elevation model (“DEM”) surface for the region from the locations of shadows that fall on the flat surface for the region.

15. The system of claim 14, further comprising a module adapted to subdivide the region into one or more cells and to determine the cloud shadow location for each of the one or more cells.

16. The system of claim 13, further comprising a module adapted to determine the cloud type for the cloud by:
obtaining cloud location, top, and base pressure information for a cloud from a weather research and forecasting (“WRF”) model; and,
using the cloud location, top, and base pressure information for the cloud to look up the cloud type in a cloud classification table.

17. The system of claim 16, wherein the cloud classification table includes entries for a predetermined number of cloud types.

18. The system of claim 17, wherein the predetermined number of cloud types is ten and wherein the cloud classification table includes entries for stratus, nimbostratus, stratocumulus, cumulus, cumulonimbus, altostratus, altocumulus, cirrostratus, cirrocumulus, and cirrus cloud types.

19. The system of claim 11, further comprising a module adapted to receive the historical output data and the historical input data including the historical physical subsystem input data and the historical physical subsystem forecasts for the solar power plant from a database stored in the memory.

20. The system of claim 11, further comprising a module adapted to receive the current input data including the current physical subsystem input data and the current physical subsystem forecasts for the solar power plant from a data acquisition system coupled to the solar power plant.
